(19) United States
(12) Patent Application Publication
(10) Pub. No.: US 2009/0119278 A1
(43) Pub. Date: May 7, 2009

(54) Continual Reorganization of Ordered Search Results Based on Current User Interaction

(76) Inventors: Tiffany B. Cross, Pflugerville, TX (US); Lisa A. Seacat, San Francisco, CA (US); Cheryl M. Sedota, Cedar Park, TX (US)

Correspondence Address: IBM CORP (AP);C/O AMY PATTILLO, P. O. BOX 161327, AUSTIN, TX, 78716, US

(21) Appl. No.: 11/936,563

(22) Filed: Nov. 7, 2007

(51) Int. Cl. G06F 7/06; G06F 17/30

(52) U.S. Cl. 707/5; 707/E17.005; 707/E17.014

(57) ABSTRACT

Responsive to each user interaction with search results to network locations returned by a search engine, a search result reorganizer predicts user interest in the search results from each dynamic user interaction. Responsive to each prediction of user interest while a user interacts any of the search results, the search result reorganizer reorders the search results to reflect the user interest.

### CROSS-REFERENCE TO RELATED APPLICATIONS

The present application is related to co-pending application: (1) U.S. patent application Ser. No. ______ (Attorney Docket No. AUS920070559US1).

### BACKGROUND OF THE INVENTION

1. Field of the Invention

The present invention relates generally to an improved network search service and, in particular to an improved computer implemented method, system, and computer program product for continually reorganizing ordered search results based on current user interaction with the search results.

2. Description of the Related Art

With the vast amount of information available across systems connected to the Internet and other networks, services that search this information and provide lists of the information to users are more and more prevalent. These search services, also typically referred to as search engines, provide an interface for a user to enter one or more search terms for the search service to use in searching for the selection of information available across the Internet or other network of systems that matches the search terms. The search service identifies one or more websites or other data links with content that matches the search terms and returns a selectable list of the websites or other data links.

Even with a search result list of website and data links, a user still has the daunting task of searching through pages of search results and selecting websites or data links in the list to determine whether a particular website or data link presents relevant information that the user is hoping to find. Some search engines, before presenting a list of search results to a user, will perform analysis of the links in the list to calculate which of the links are most relevant to the search terms and to place the links with the greatest relevance at the top of the list. In addition, some search engines will allows a user to select from a list of additional preset search terms, such as price or location, for the search engine to then apply in ordering a list of search results by the additional search terms. Current search engine ordering techniques are still limited in that once the search engine orders search results according to relevance to search terms or user selection from predefined search terms, the ordering is then fixed for that search result list, regardless of additional user interactions with the ordered search results.

### SUMMARY

Therefore, the present method, system, and program provide for continual reorganization of search results based on dynamic user interaction with those search results.

In one embodiment, responsive to each user interaction with search results to network locations returned by a search engine, a search result reorganizer predicts user interest in the search results from each dynamic user interaction. Responsive to each prediction of user interest while a user interacts with the search results, the search result reorganizer reorders the search results to reflect the user interest.

In predicting user interest in the search results, the search result reorganizer detects a first amount of time a user selects to access the display interface with a first selection of the search results before selecting to view a next selection of the search results. The search result reorganizer detects at least one common content element of the pages accessible from the first selection of the search results. Then, the search result reorganizer predicts user interest in the at least one common content element based on the first amount of time.

In addition, in predicting user interest in the search results, the search result reorganizer detects an amount of time a particular page accessed from a particular link within the search results is opened. The search result reorganizer detects at least one content element of the particular page. Then, the search result reorganizer predicts user interest in at least one content element based on the amount of time the particular page is opened.

Further, in predicting user interest in the search results, the search result reorganizer detects a first amount of time of a first user interaction with the search results and a first content element of at least one page accessible from the search results associated with the first user interaction with the search results. The search result reorganizer detects a second amount of time of a second interaction of a user with the search results and a second content element of at least one additional page accessible from the search results associated with the second interaction of the user with the search results. Then, the search result reorganizer predicts greater user interest in one of the first content element and the second content element based on which of the first amount of time and the second amount of time is the longest.

In addition, in predicting user interest in the search results, the search result reorganizer detects a user interaction of a user selecting to download a file from a website accessed from a particular link from among the search results. The search result reorganizer detects a type of content of the file. Then, the search result reorganizer predicts user interest in the content of the file based on the user selecting to download the file from the website.

In reordering the search results to reflect the user interest while the user interacts with the search results, the search result reorganizer detects the predicted user interests based on each user interaction with at least one of the search results including at least one first content element from at least one of the pages accessible from at least one of the search results that is of highest interest to the user and at least one second content element from at least one of the additional pages accessible from at least one of the search results that is of lowest interest to the user. The search result reorganizer reorders the search results descending from at least one first link from among the search results with the same at least one first content element of highest interest to at least one second link from among the search results with the same at least one second content element of lowest interest to the user.

In addition, the search result reorganizer receives the search results initially ordered by a search engine specifying the search results related to at least one search term in response to a search query with the at least one search term. The search result reorganizer may also determine user interest and request an updated selection of search results, reordered according to user interest, by submitting a search query with the initial search term and at least one additional search term from the predicted user interests.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting examples of components of a search result reorganizer in accordance with the method, system, and computer program of the present invention;

FIG. 2 is a block diagram illustrating one example of a network environment in which a search result reorganizer may be implemented;

FIG. 3 is a block diagram depicting one embodiment of a computer system in which the present invention may be implemented;

FIG. 4 is a block diagram illustrating an example of a process of dynamically predicting user interests based on current user interactions with search result links and dynamically reordering search result links based on updates to the predicted user interests;

FIG. 5 is a block diagram illustrating an example of the search result links for a particular search query reordered responsive to user interaction with the search result links;

FIG. 6 is a high level logic flowchart depicting a process and program for triggering a search result reorganizer to manage reordering of search result links according to user interests predicted from user interactions with the search result links;

FIG. 7 is a high level logic flowchart depicting a process and program for a search result reorganizer reordering search result links responsive to user interest predicted from current user interaction with the search result links; and

FIG. 8 is a a high level logic flowchart illustrating the deployment of the search result reorganizer process software.

### DETAILED DESCRIPTION OF THE PREFERRED EMBODIMENT

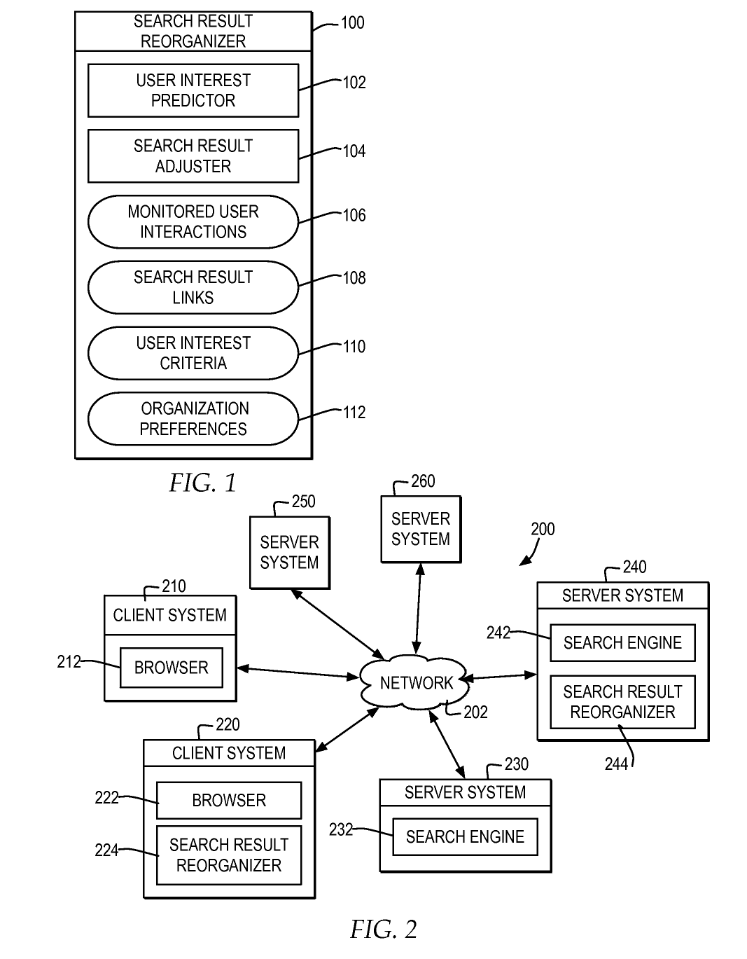

With reference now to the Figures, and in particular with reference now to FIG. 1, a block diagram illustrates examples of components of a search result reorganizer in accordance with the method, system, and computer program of the present invention. It is important to note that in additional or alternate embodiments, search result reorganizer 100 may include additional or alternate components and that the components of search result reorganizer 100 may function within a single computer system or be distributed among different systems across a network or among different logical systems.

In the embodiment, search result reorganizer 100 includes search result links 108 from a search engine or type of network search service. Search result links 108 may include multiple types of links for accessing multiple types of locations, including, but not limited to, network links for accessing a website or other network address and storage links for accessing data from a data storage system. In addition to a link address, each link may include a summary of contents of the web page accessible at the link address, a preview image of one or more downloadable images or other media available at the link, a link to previously cached images from the link, a percentage relevance to the search terms, and other information provided by a search engine or available from the tags, metadata or other data which describes the content of or data within the website or data accessible at a link address. Search result links 108 may include search results from one or more search engines accessed in one or more ways including, but not limited to, accessed directly from a search engine, accessed from a browser application receiving the search results, or accessed from a server system managing the search results. In addition, search result links 108 may include lists of links, individual links, and data structures including links, for example. Further, search result links 108 may include the indexing information accessed by a search engine in selecting search result links 108 for the search terms from among a database of multiple available links.

In addition, search result reorganizer 100 includes user interest predictor 102. User interest predictor 102 accesses any current user interaction with search result links 108 and stores current user interactions as monitored user interactions 106. In one example, user interest predictor 102 accesses user interaction with search result links 108 by detecting characteristics of user interactions with a display of search result links 108 within a browser application. User interactions included in monitored user interactions 106 may be cached only while a user accesses a browser window with search results or monitored user interactions 106 may be stored when detected and analyzed to detect patterns of user interaction across different sets of search results.

User interest predictor 102 analyzes each current user interaction with search result links 108 in view of the content of the links interacted with, and in view of user interactions previously stored in monitored user interactions 106 with the search results, to predict user interest in the search result links 108. In one example, user interest criteria 110 specify rules for analyzing user interactions and detecting the content of the links interacted with to determine levels of user interest in the search results. It is important to note that user interest criteria 110 may be specified according to at least one criteria including, but not limited to, a service providing search result reorganizer 100, a search engine providing search result links 108, or a user account for the user accessing search result links 108 at a browser.

User interest criteria 110 may specify one of multiple types and characteristic of user interaction for user interest predictor 102 to capture. For example, user interest criteria 110 may direct user interest predictor 102 to access current user interaction with search result links 108 indicating which link a user selects from search result links 108. In another example, user interest criteria 110 specify accessing user interaction with search result links 108 indicating how long a user spends looking at a web page accessed from a particular link in search result links 108. Further, user interest criteria 110 may specify accessing user interaction with search result links 108 indicating which items are selected within a web page accessed from a particular link in search result links 108, such as a downloaded item. Moreover, user interest criteria 110 may specify accessing user interaction with search result links 108 may indicating how long a user viewed a display of a portion of search result links 108 before requesting to view a next or previous portion of search result links 108.

In addition, user interest criteria may specify when to trigger user interest predictor 102 to detect content for a link in search result links 108. In one example, user interest criteria 110 may direct user interest predictor 102 to detect all of or the similar portions of the content of all links on a page including a portion of search result links 108 viewed by a user. In another example, user interest criteria 110 may direct user interest predictor 102 to only detect the content of links that a user selects to view from a display of search result links 108. In yet another example, user interest criteria 110 may direct user interest predictor to detect the content of links that a user positions a cursor, pointer or other selection device over for a particular amount of time.

In directing user interest predictor 102 to detect content for a link, user interest criteria 110 may designate detecting the content specified for the link in search result links 108 or may perform additional analysis or filtering to detect the content of the link. For example, user interest criteria 110 may direct user interest predictor 102 to search and identify the content of a website accessible from a link within search result links 108 when a user selects the link or separate from user selection of the link. In another example, user interest criteria 110 may direct user interest predictor 102 to search the tagging, metadata or header information of an accessed website or objects within the accessed website from a link in search result links 108 for content of the accessed website. In yet another example, user interest criteria 110 may direct user interest predictor 102 to determine content of links from the titles or descriptions of images or other media which is displayed, downloadable, or streamable from an accessed website from a link in search result links 108.

In addition, in directing user interest predictor 102 to detect content for a link, user interest criteria 110 may designate detecting particular types of content. For example, user interest criteria 110 may designate detecting redundant words in the content for a particular link or redundant words across the content of multiple links.

Further, user interaction criteria 110 may include instructions for user interest predictor 102 to narrow the content summary and descriptive terms for a website to those terms which relate to the at least one search term in the search query triggering search result links 108. In another example, user interaction criteria 110 may specify a database, including a dictionary, thesaurus, or other data system for indicating relationships of data content, to access for each search term to determine the types of content related to the search term which should be identified in the content summary and descriptive terms for a website.

Thus, once user interest predictor 102 identifies a user interaction and detects content associated with the user interaction, user interest predictor 102 then predicts current user interests in search result links 108. In one example, user interest predictor 102 updates the content across the links most viewed by the user, with each user interaction, and predicts that a user is most interested in content associated with the longest user interactions. In addition, user interest predictor 102 predicts that a user is most interested in the redundant content of a particular website or multiple websites accessed from among search result links 108 that the user views for the longest period. Further, user interest predictor 102 predicts that a user is most interested in the types of content, such as media, that the user selects within a website from among search result links 108 based on each user interaction with the different types of content within a website. Moreover, user interest predictor 102 predicts that a user is not interested in redundant content among a selection of search result links 108 which are displayed, but skipped or minimally interacted with by the user.

A search result adjuster 104 within search result reorganizer 100 dynamically reorders search result links 108 from those links with content indicating most user interest to those links with content indicating least user interest, where user interest is determined by user interest predictor 102 from current and previous user interactions in monitored user interactions 106 and content of search result links with which a user interacts as applied to user interest criteria 110. In one example, for each user interaction detected by user interest predictor 102 and analyzed to detect user interests, search result adjuster 104 may reorder search result links 108 to reflect each respective change in user interests. In another example, organization preferences 112 specifies a number of links a user prefers to access from search result links 108 or an amount of time a user prefers to view a display of search result links 108 before search result adjuster 104 begins reordering search result links 108. One or more of a user, a website including a search engine interface, a browser, or a search engine may specify user organization preferences 112.

In particular in reordering search result links 108, search result adjuster 104 may determine, based on the content summary of unaccessed websites from among search result links 108, whether the unaccessed website links have the potential for greater user interest based on current user interest. In addition, in reordering search result links 108, search result adjuster 104 may reorder an accessed website for a link within search result links 108, but since the user has already accessed the link, the link is marked or graphically distinguished to indicate a previous access.

In another example, search result adjuster 104 dynamically reorders search result links 108 by determining additional search terms from the content of most interest in the user interests and sending the previously entered search terms by the user and the additional search terms to a search engine to request the search engine generate a new list of search result links. In one example, a search engine accessed by search result adjuster 104 may include an option allowing a user or search result adjuster 104 to enter additional terms to order previously accessed search result links. In another example, a search engine accessed by search result adjuster 104, in response to the additional search terms, may return a list of search result links which includes links in addition to the links previously accessed in search result links 108, but search result adjuster 104 may filter out the new links, add deleted links, or otherwise graphically distinguish new or deleted links within a display of the reordered search result links received from the search engine based on a search with the additional terms.

In one example, once search result links 108 are reordered, search result adjuster 104 may trigger the adjustment of the graphical display of at least a portion of search result links 108 within a browser interface or other graphical user interface displaying at least a portion of search result links 108. In another example, a user may view a sequence of links accessed in search result links 108, such as by viewing a slideshow of the links which advance one at a time in order, where search result adjuster 104 reorders search result links 108 underlying the sequence of links.

With reference now to FIG. 2, a block diagram depicts one example of a network environment in which a search result reorganizer may be implemented. It is important to note that network environment 200 is illustrative of one type of network environment which may support search engines, distribution of search results, and search result reorganization, however, client systems, server systems and other components of a system for supporting search services may be implemented in other network environments. In addition, it is important to note that the distribution of systems within network environment 200 is illustrative of a distribution of systems, however, other distributions of systems within a network environment may be implemented.

As illustrated, multiple systems within network environment 200 may be communicatively connected via network 202, which is the medium used to provide communications links between various devices and computer systems communicatively connected. Network 202 may include permanent connections such as wire or fiber optics cables and temporary connections made through telephone connections and wireless transmission connections, for example. Network 202 may represent one or more of packet-switching based networks and telephony based networks, local area and wire area networks, public and private networks.

Network 202 may implement one or more layers of one or more types of network protocol stacks which may include one or more of a physical layer, a link layer, a network layer, a transport layer, a presentation layer, and an application layer. For example, network 202 may implement one or more of the Transmission Control Protocol/Internet Protocol (TCP/IP) protocol stack or an Open Systems Interconnection (OSI) protocol stack. In addition, for example, network 202 may represent the worldwide collection of networks and gateways that use the TCP/IP suite of protocols to communicate with one another. In other examples, network 202 may implement one or more different types of protocol stacks and other types of protocol stacks.

Network environment 200 may implement multiple types of network architectures. In one example, network environment 200 may be implemented using a client/server architecture, where computing systems requesting data or processes are referred to as clients and computing systems processing data requests and processes are referred to as servers. In another example, network environment 200 may be implemented in a peer-to-peer network architecture. In yet another example, network environment 200 may be implemented in a grid architecture. It will be understood that other types of network architectures and combinations of network architectures may be implemented in network environment 200.

In the embodiment, as illustrated, one or more of client systems 210 and 220, server systems 230, 240, 250, and 260 are communicatively connected via network 202. Client systems 210 and 220 are representative of one or more client computing systems at which a user accesses a browser, application interface or network service, such as browsers 212 and 222, through which requests for data are sent to one or more of server systems 230, 240, 250, and 260 and through which data delivered from one or more of server systems 230, 240, 250, and 260 is output. In one example, server systems 230 and 240 represent server systems which include search engines, such as search engines 232 and 242, for searching web pages and other data available from one or more of server systems 230, 240, 250, and 260 which are relevant to a search query, including one or more search terms. It will be understood that server systems 230, 240, 250, and 260 are representative of one or more computing systems which may be searched, queried, accessed, and which may control delivery of data via network 202 and that additional or alternate systems may be accessible via network 202. In addition, it will be understood that each of client systems 210 and 220 may be implemented as a server for receiving requests for data and delivering data to other systems.

In one example, search engines 232 and 242 may maintain a database, such as an index, of links, contents, and other information about web pages available from one or more server systems, such as server systems 230, 240, 250, and 260, where the database of links is filtered for each search query to identify a selection of web pages with contents relevant to the search terms of a search query. In another example, search engines 232 and 242 may query other search services, search agents, or search engines with one or more of the search terms of a search query, where the other search services, search agents, or search engines filter through web pages and return a list of web pages with contents relevant to at least one of the search terms of the search query. Further, it will be understood that search engines 232 and 242 may implement additional or alternate methods of identifying a list of search results links relevant to a particular search query.

In one example, client system 210 includes a browser 212. Browser 212 interfaces with a website or other network location which includes an interface for search queries served by search engine 242. For example, browser 212 may interface with a website hosted by one of server systems 240, 250, and 260. When a user requests a search query for one or more search terms within the interface of the website, the website host passes, transmits, or communicates the search terms to search engine 242. Search engine 242 determines a selection of websites which are relevant to the search terms and returns search result links to the calling website for output within browser 212 or plugs in the compiled search result links within a particular portion of the website.

As a user interacts with the search result links returned within the website accessed by browser 212, search result reorganizer 244 monitors the user interactions with the search result links. In one example, the website host enables search result reorganizer 244 to monitor user interaction specifying the time between selections of links from the search result links or the amount of time a website selected from the search result links is accessed. In addition, search result reorganizer 244 may monitor additional types of user interaction with the search results links dependent upon indicators of user interaction indicated by browser 212 and the website host or search engine 242.

With each new user interaction or after a specified number of user interactions monitored by search result reorganizer 244 with search result links specified by search engine 242, search result reorganizer 244 determines user interests based on the user interactions with the search result links and detected content of the search result links. Based on the user interests determined from dynamic user interaction with the search result links, search result reorganizer 244 reorders the search result links specified by search engine 242 and returns the reordered search result links to the website host, search engine 242, or browser 212.

In another example, client system 220 includes a browser 222 and search result organizer 224. Browser 222 interfaces with a website or other network site which includes an interface for searching facilitated by a search engine, such as search engine 242 or a search engine 232. For example, browser 222 may interface with a website hosted by one or more of server systems 230, 240, 250, or 260. When a user requests a search query for one or more search terms within the interface of the website, the website host passes the search terms to a search engine.

In one example, where search result reorganizer 224 is fully operational from client system 220, the website host may access a search engine such as search engine 232. Search result reorganizer 224 detects the search result links received by browser 222 from search engine 232 and monitors user interactions with the search result links, including interaction with websites accessed from the search result links, within browser 222. In particular, for each user interaction or after a specified number of user interactions with the search result links, search result reorganizer 224 also detects the content of websites available from the search result links and analyzes the length of user interactions with content to determine user interests. In one example, search result reorganizer 224 detects the content of websites accessed from search result links by reading the tags, metadata or other data indicating the content of a website within the website document. Based on the determined user interests, in one example, search result reorganizer 224 reorders the search result links as applied or displayed within browser 222. In another example, based on the determined user interests, search result reorganizer 224 determines additional search terms and modifies the search terms of the search query in the website displayed in browser 222 and requests an updated search query based on the previously entered search terms by the user and the additional search terms generated based on user interest in a current list of search result links.

In another example, where search result reorganizer 224 is a plug in or component of browser 222, including only a portion of the components described with reference to search result reorganizer 100, the website host of the website accessed within browser 222 may access a search engine such as search engine 242 which also implements search result reorganizer 244, including the additional portion of components described with reference to search result reorganizer 100 not performed by search result reorganizer 224. For example, search result reorganizer 224 may detect user selections of websites to access from the search result links and report the selections and length of selections to search result reorganizer 244, where search result reorganizer 244 then detects the content of the accessed websites, determines the user interest from the user interaction information reported by search result reorganizer 224 and the content detected by search result reorganizer 244, and reorders the search result links. In one example, search result reorganizer 244 sends the reordered search result links to search result reorganizer 224 for display within the website accessed within browser 222 or for search result reorganizer 224 to direct the website host of the website accessed within browser 222 to adjust the search result links to the reordered search result links.

It is important to note that in addition to the distributions of search result reorganizer 100 described with reference to search result reorganizer 224 and search result reorganizer 244, search result reorganizer 100 may be distributed among additional or alternate systems in a network environment. In addition, search result reorganizer 100 may be distributed among multiple logical network partitions distributed within a single client system or server system or across multiple client systems and server systems. Further, multiple physical, logical or virtual instances of search result reorganizer 100 may be initiated at a client system or server system.

In particular, while it is understood that the process software of the search result reorganizer may be deployed by manual loading directly in client systems, such as search result reorganizer 224 of client system 220, directly in server systems, such as search result reorganizer 244 of server system 240, and proxy computer systems (not depicted) via loading a storage medium such as a CD, DVD, etc., the process software may also be automatically or semi-automatically deployed into a computer system by sending the process software to a server system or a group of server systems. The process software is then downloaded into the client computers that will execute the process software. Alternatively, the process software is sent directly to the client system or server system via email or other electronic communication. The process software is then either detached to a directory or loaded into a directory by button on the email or other electronic communication that executes a program that detaches the process software into a directory. Another alternative is to send the process software directly to a directory on the client system or server system hard drive. When there are any proxy servers, the process will select the proxy server code, determine on which computers to place the proxy servers' code, transmit the proxy server code, then install the proxy server code on the proxy computer. The process software will be transmitted to the proxy server, then stored on the proxy server.

In addition, in particular, while it is understood that the process software of the search result reorganizer may be deployed separately from a search engine, the process software may also be fully or partially integrated with or coexist with the search engine applications, search engine services, and operating systems on client systems and server systems in the network environment where the process software will function. Further, the process software of the search result reorganizer may be available as on demand on a shared server system.

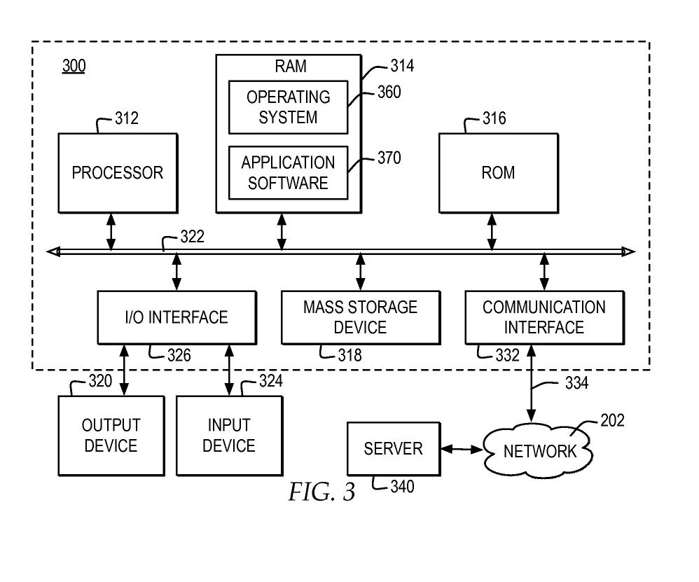

With reference now to FIG. 3, a block diagram illustrates one embodiment of a computer system in which the present invention may be implemented. The processes, methods, computer program products, and systems of the present invention may be executed in a variety of systems, including a variety of computing systems, such as computer system 300, communicatively connected to a network, such as network 302.

Computer system 300 includes a bus 322 or other communication device for communicating information within computer system 300, and at least one processing device such as processor 312, coupled to bus 322 for processing information. Bus 322 includes low-latency and higher latency paths that are connected by bridges and adapters and controlled within computer system 300 by multiple bus controllers. When implemented as a server, computer system 300 may include multiple processors designed to improve network servicing power. Where multiple processors share bus 322, an additional controller (not depicted) for managing bus access and locks may be implemented.

Processor 312 may be a general-purpose processor such as IBM's PowerPC™ processor that, during normal operation, processes data under the control of an operating system 360, application software 370, middleware (not depicted), and other code accessible from a dynamic storage device such as random access memory (RAM) 314, a static storage device such as Read Only Memory (ROM) 316, a data storage device, such as mass storage device 318, or other data storage medium. Operating system 360, application software 370, or other layers of software may implement one or more of the components of search result reorganizer 100 described in FIG. 1.

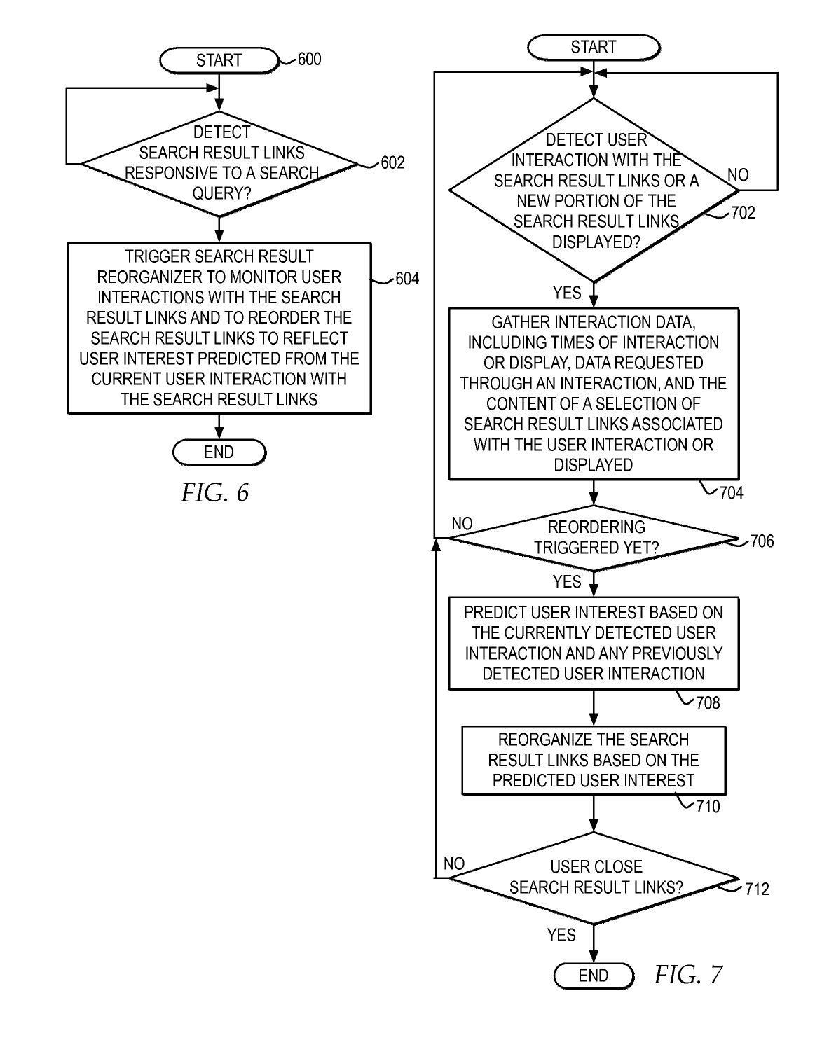

In one embodiment, the operations performed by processor 312 may control detecting search result links, predicting user interest in search result links based on current user interactions with the search result links, and dynamically reorganizing the search result links based on the current user interest, as described in the operations of the flowcharts of FIGS. 6-8 and other operations described herein. Operations performed by processor 312 may be requested by operating system 360, application software 370, middleware or other code or the steps of the present invention might be performed by specific hardware components that contain hardwired logic for performing the steps, or by any combination of programmed computer components and custom hardware components.

The present invention may be provided as a computer program product, included on a computer or machine-readable medium having stored thereon the executable instructions of a computer-readable program that when executed on computer system 300 cause computer system 300 to perform a process according to the present invention. The terms “computer-readable medium” or “machine-readable medium” as used herein includes any medium that participates in providing instructions to processor 312 or other components of computer system 300 for execution. Such a medium may take many forms including, but not limited to, storage type media, such as non-volatile media and volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 300 can read and which is suitable for storing instructions. In the present embodiment, an example of a non-volatile medium is mass storage device 318 which as depicted is an internal component of computer system 300, but will be understood to also be provided by an external device. Volatile media include dynamic memory such as RAM 314. Transmission media include coaxial cables, copper wire or fiber optics, including the wires that comprise bus 322. Transmission media can also take the form of acoustic or light waves, such as those generated during radio frequency or infrared data communications.

Moreover, the present invention may be downloaded or distributed as a computer program product, wherein the computer-readable program instructions may be transmitted from a remote computer such as a server 340 to requesting computer system 300 by way of data signals embodied in a carrier wave or other propagation medium via network 202 to a network link 334 (e.g. a modem or network connection) to a communications interface 332 coupled to bus 322. In one example, where processor 312 includes multiple processor elements, then a processing task distributed among the processor elements, whether locally or via a network, may represent a computer program product, where the processing task includes program instructions for performing a process or program instructions for accessing Java (Java is a registered trademark of Sun Microsystems, Inc.) objects or other executables for performing a process. Communications interface 332 provides a two-way data communications coupling to network link 334 that may be connected, for example, to a local area network (LAN), wide area network (WAN), or directly to an Internet Service Provider (ISP). In particular, network link 334 may provide wired and/or wireless network communications to one or more networks, such as network 202. Further, although not depicted, communication interface 332 may include software, such as device drivers, hardware, such as adapters, and other controllers that enable communication. When implemented as a server, computer system 300 may include multiple communication interfaces accessible via multiple peripheral component interconnect (PCI) bus bridges connected to an input/output controller, for example. In this manner, computer system 300 allows connections to multiple clients via multiple separate ports and each port may also support multiple connections to multiple clients.

Network link 334 and network 202 both use electrical, electromagnetic, or optical signals that carry digital data streams. The signals through the various networks and the signals on network link 334 and through communication interface 332, which carry the digital data to and from computer system 300, may be forms of carrier waves transporting the information.

In addition, computer system 300 may include multiple peripheral components that facilitate input and output. These peripheral components are connected to multiple controllers, adapters, and expansion slots, such as input/output (I/O) interface 326, coupled to one of the multiple levels of bus 322. Input device 324 may include, for example, a microphone, a video capture device, a body scanning system, a keyboard, a mouse, or other input peripheral device, communicatively enabled on bus 322 via I/O interface 326 controlling inputs. In addition, an output device 320 communicatively enabled on bus 322 via I/O interface 326 for controlling outputs may include, for example, one or more graphical display devices, audio speakers, and tactile detectable output interfaces, but may also include other output interfaces. In alternate embodiments of the present invention, additional or alternate input and output peripheral components may be added.

Those of ordinary skill in the art will appreciate that the hardware depicted in FIG. 3 may vary. Furthermore, those of ordinary skill in the art will appreciate that the depicted example is not meant to imply architectural limitations with respect to the present invention. For example, computer system 300 may also be a tablet computer, laptop computer, or telephone device.

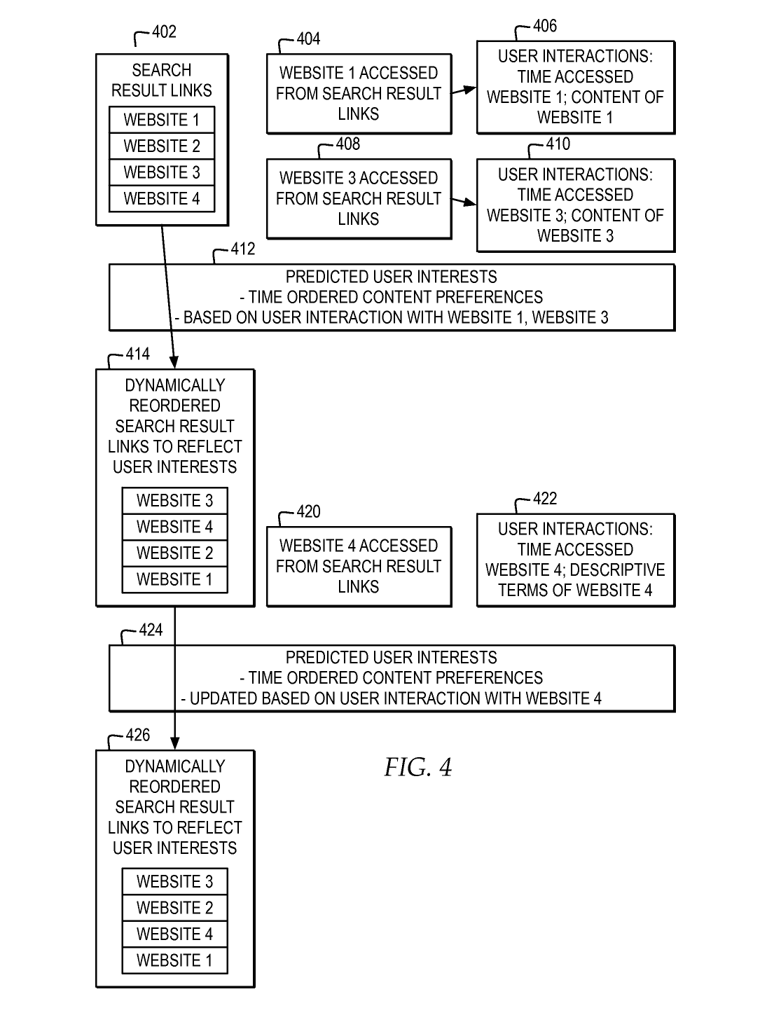

Referring now to FIG. 4, a block diagram illustrates examples of a process of dynamically predicting user interests based on current user interactions with search result links and dynamically reordering search result links based on updates to the predicted user interests. The example is described with reference to data received by, detected by, processed by, and results returned by a search result reorganizer, such as previously described search result reorganizers 100, 224, or 244. In the example the search result reorganizer determines, detects, or receives search result links 402 for a search query. Search result links 402 include multiple links to websites that are relevant to at least one search term. Search result links 402 may be preordered by the search engine selecting search result links 402 for a search query according to factors such as relevance to the search terms for the search query or promotional interests, such as promoting those websites with which a search engine has a contractual relationship to promote.

A user may select to interact with at least a portion of search result links 402 displayed through a selectable list within a browser window. In particular, where only a portion of search result links 402 are displayed within the display area of a browser window, a user may select to interact with another portion of search result links 402 by selecting an arrow or other function that triggers accessing and displaying a next portion of search result links 402 within a browser window. In addition, a user may select to interact with search result links 402 by triggering a slideshow viewer or other type of viewer that automatically accesses and displays links from search result links 402 sequentially as triggered by a timer or user request to move to a next link.

In the example, the search result reorganizer monitors each user selection to access a website from search result links 402. For example, as illustrated at reference numeral 404, the search result reorganizer detects a “website 1” accessed from search result links 402, where “website 1” is listed as the first link in search result links 402. In addition, as illustrated at reference numeral 408, the search result reorganizer detects a “website 3” accessed from search result links 402, where “website 3” is listed as the third link in search result links 402. In one example, a user may select to view only a selection of the links in search result links 402 in an order selected by the user.

For each website accessed, the search result reorganizer detects user interactions with the accessed websites and the relevant content of accessed websites. As illustrated at reference numerals 406 and 410, the user interactions include the amount of time each website is accessed and the relevant content determined for the website. As previously noted, the relevant content of the website may include keywords identified in the tags or other metadata of a website, terms included in headings, outlines, or lists, in a website, terms used to name images within the website, and other types of content which identify the scope of the information accessible from the website as designated in the user interest criteria. Although not depicted, for each website not accessed, the search result reorganizer may also detect a lack of user interaction with one or more links and the relevant content of the unaccessed websites.

Based on the user interactions and relevant content illustrated at reference numerals 406 and 410, the search result reorganizer predicts user interests, as illustrated at reference numeral 412. The predicted user interests illustrated at reference numeral 412 may include, but are not limited to, a determination of the types of content preferred by the user in order according to the amount of time the user spends looking at the types of content. In additional or alternate examples, additional or alternate factors, including previously monitored user interactions and previously determined user interests may effect the current determination of user interests. Advantageously, however, even if previous user interactions and user interests are factors in predicting current user interests, the currently detected user interactions with a set of search result links dynamically effect user interests in search result links for a particular search query.

Based on the predicted user interests illustrated at reference numeral 412, the search result reorganizer dynamically reorders the search result links to reflect the currently predicted user interest, predicted from current user interactions, as illustrated at reference numeral 414. In the example, the predicted user interests illustrated at reference numeral 412 indicate that “website 3” is of most interest, with the ordering progressing to “website 1” of least interest. Although “website 2” and “website 4” are not yet accessed, these websites are ordered to reflect the predicted user interest in the content of these websites based on the content summary and other information accessed about these websites in view of the predicted user interests illustrated at reference numeral 412.

Next, as illustrated at reference numeral 420, a user interacts with the “website 4” from the dynamically reordered search result links illustrated at reference numeral 414. The search result reorganizer detects the user interactions with “website 4”, including a time accessing the website and the additional descriptive terms of the website, as illustrated at reference numeral 422. The search result reorganizer updates the predicted user interests, as illustrated at reference numeral 424, to reflect the user interaction with “website 4”. Based on the updates to the predicted user interests, as illustrated at reference numeral 424, the search result reorganizer dynamically reorders the search result links to reflect the updated user interests, as illustrated at reference numeral 426. In particular, in the example, the predicted user interests illustrated at reference numeral 424 indicate that “website 3” is still of most interest, with the ordering progressing to “website 1” of least interest, but the ordered positions of “website 2” and “website 4” are adjusted from the previous positions illustrated at reference numeral 414.

As illustrated, with each user interaction or following a series of user interactions or lack of user interaction, the search result reorganizer updates or predicts new user interests to indicate current user interactions with the search result links and then dynamically reorders the search result links according to the predicted user interests while the search result links are available for further user interaction. By updating the predicted user interests after each user interaction, the probability increases that with user interaction and reordering that the reordered search result links include links at the top of the preexisting search result links which are of most interest to the user and links at the bottom of the preexisting search result links that are of least interest to the user.

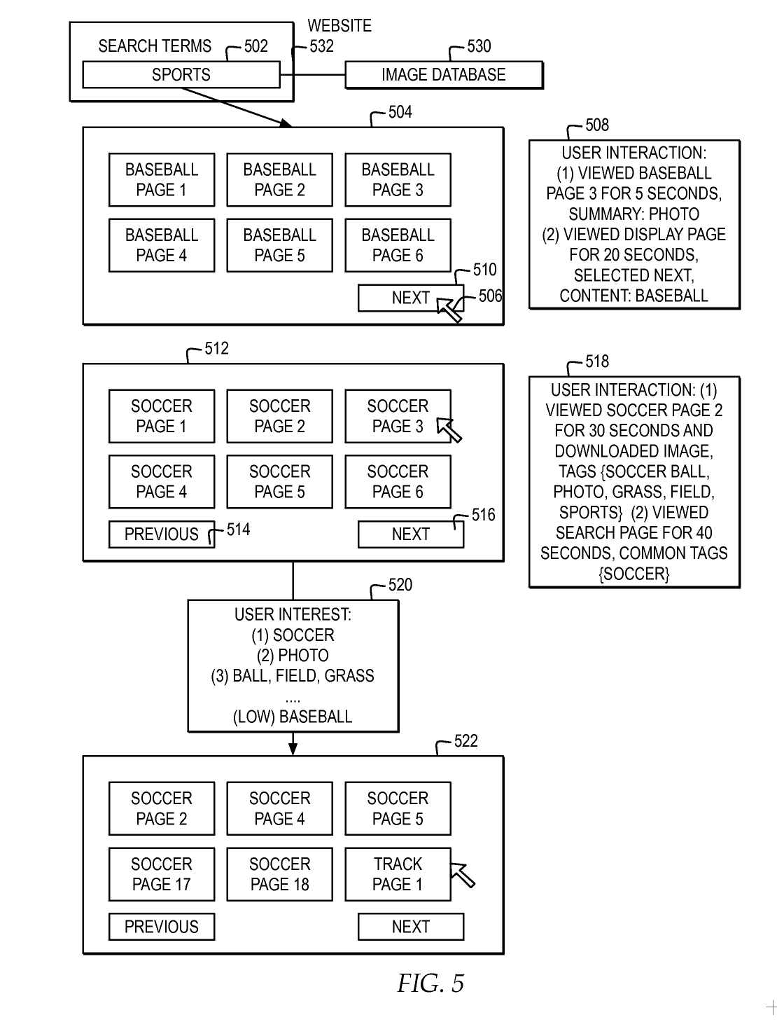

With reference now to FIG. 5, a block diagram illustrates an example of the search result links for a particular search query reordered responsive to user interaction with the search result links. In the example, a user accesses a website 532 with a search interface 502 into which a user may enter one or more search terms for a search query that searches an image database 530 according to entered search terms. In particular, in the example, a user enters a search term of “sports” for a search query of the images within image database 530 associated with sports.

A display window 504 includes a first portion of the search result links initially returned to website 532 relevant to the search term “sports”. As illustrated, display window 504 includes multiple links for images associated with baseball, which is relevant to a search query of “sports” depicted as “baseball page 1”, “baseball page 2”, “baseball page 3”, “baseball page 4”, “baseball page 5”, and “baseball page 6”. Although not depicted, each of the link references, such as “baseball page 1” may be represented by a reduced image of the full image, such as a thumbnail image, available at the link. In one example, if a user selects one of the links, such as selecting “baseball page 1” through positioning cursor 506 or entering other selection input, website 532 opens a new window or displays within display window 504 a webpage through which the user may view and download the particular baseball image from image database 530.

As illustrated at reference numeral 508, the search result reorganizer tracks user interaction within the portion of the search result links within display window 504. In the example, the user interaction depicted at reference numeral 508 includes user interactions with a particular link “baseball page 3” for a time period of “5 seconds” and the filtered content, from a summary for the link, of “photo”. In addition, in the example, the user interaction depicted at reference numeral 508 includes user interaction in general with an amount of time of “20 seconds” that display window 504 is accessed before the user selects to view a next portion of the search result links through selection of a next option 510 within display window 504. In addition, in the search result reorganizer monitoring an amount of time a portion of the search result links within display window 504 are open, the search result reorganizer may detect the common content among the portion of the search result links within display window 504, such as “baseball”.

In the example, the search result reorganizer organization preference is set for the search result reorganizer to wait to predict user interest and reorder the search result links until after a user has viewed portions of the search result links for a total of one minute. In another example, the search result reorganizer organization preference may be set to wait for the user to select a next option, such as next options 510 and 516, to view a next portion of search result links or to select a previous option, such as previous option 514, to view a previous portion of search result links.

In particular, in the example, when the user selects next option 510, 20 seconds have passed in the count of user interaction with the search result links and website 532 displays a next portion of the search result links as initially ordered by the search engine returning the search result links as illustrated in display window 512. Display window 512 includes multiple links for images associated with soccer which is relevant to a search query of “sports” depicted as “soccer page 1”, “soccer page 2”, “soccer page 3”, “soccer page 4”, “soccer page 5”, and “soccer page 6”. As previously noted, although not depicted, each of the link references, such as “soccer page 1” may be represented by a reduced image of the full image available at the link.

As depicted at reference numeral 518, the search result reorganizer tracks user interaction with the portion of the search result links within display window 512. In the example, the user interaction depicted at reference numeral 518 includes user interactions with a particular link “soccer page 2” for a time period of “30 seconds” with a detected user download of the image from the link and the content, from the tags of the downloaded image, of {soccer ball, photo, grass, field, sports}. A download is one example of a type of user interaction with the link that when detected by the search result reorganizer provides an indicator of user interest in a particular image. In addition, in the example, the user interaction depicted at reference numeral 508 includes user interaction in general with an amount of time of “40 seconds” that display window 512 is currently accessed and with the common tagged content among the links within display window 512 of “soccer”.

In the example, the search result reorganizer detects that the total amount of time viewing the search result links, from the user interaction illustrated at reference numeral 508 of 20 seconds and reference numeral 518 of 40 seconds, is one minute. In response to detecting that the condition in the organization preferences for reordering search results is set, the search result reorganizer first predicts user interests 520 based on the recorded user interaction illustrated at reference numerals 508 and 518. In the example, the search result reorganizer predicts, based on the amount of time that the user spent looking at a particular soccer image, the user downloading the image with a tags including “soccer ball” and the display window 512 open for the longest of any display windows with the common tag of “soccer”, that “soccer” is of most interest to the user, as illustrated in user interest 520. In addition, because the user selected “baseball page 3” and “soccer page 2” which both include the content of “photo”, the search result reorganizer predicts that a next interest of importance of the user is images which are photos as depicted in user interest 520. Further, because the downloaded image from “soccer page 2” also includes the tags of “ball”, “field”, “grass” and “sports”, the search result reorganizer predicts that the content of “ball”, “field” and “grass” are of importance to the user as illustrated in user interest 520, and discards the “sports” tag since this is the primary search term entered by the user. Moreover, with regard to the user interaction depicted at reference numerals 508 and 518, because the user only selected to view one image from the baseball images, quickly looked at the baseball image, did not download the image, quickly moved to a next portion of the search result links, and then downloaded a different image, the search result reorganizer predicts that baseball images are of low interest to the user.

As illustrated in display window 522, the search result reorganizer applies user interest 520 to the current ordering of the search result links and reorders the search result links to reflect user interest 520. In the example, display window 522 includes the search result links reordered to place those links predicted as most interesting to the user first, followed by links predicted to be of less interest. In the example, the search result organizer determines that the links of most interest to the user, in order, include “soccer page 2”, “soccer page 4”, “soccer page 5”, “soccer page 17”, “soccer page 18”, and “track page 1”.

“Soccer page 2”, “soccer page 4”, and “soccer page 5” were previously included in display window 522 and these pages include content which the search result reorganizer reorders to the top of the list of search result links in view of user interest 520. “Soccer page 2”, “soccer page 4”, and “soccer page 5” are examples of links previously viewed by a user, but ordered of high user interest according to user interest 520 in the reordered search result links.

“Soccer page 17” and “soccer page 18” were previously ordered lower in the search result links than “soccer page 6”. In particular, for purposes of illustration, each of the soccer pages were originally ordered in the search result links in numerical order. Without search result reorganizer reordering the search result links, “soccer page 17” and “soccer page 18” would have been accessible in a display window accessed following display window 512. The search result reorganizer determines that “soccer page 17” and “soccer page 18” are of greater interest to the user than soccer pages 7-16 based on the content of “soccer page 17” and “soccer page 18” rating higher in user interest 520 and search result reorganizer reorders “soccer page 17” and “soccer page 18” to a position following “soccer page 5”.

“Track page 1” was previously ordered lower in the search result links than all the soccer pages. In particular, for purposes of illustration, each of the track pages were originally ordered in the search result links following all the soccer links, such as a last soccer link page of “soccer page 20”. Without search result reorganizer reordering the search result links, “track page 1” would have been accessible in a display window following display window 512 and the display of all other soccer pages. According to an advantage, search result reorganizer determines that “track page 1” is of greater interest to the user than “soccer page 19” and “soccer page 20” based on the content of “track page 1” rating higher in user interest 520 and search result reorganizer reorders “track page 1” to a position following “soccer page 18”.

Although not depicted, with each user interaction with the search result links, such as the portion of the search result links illustrated in display window 522, the search result reorganizer updates the predicted user interest in the image links and reorders the search result links according to the currently updated user interest.

With reference now to FIG. 6, a high level logic flowchart depicts a process and program for triggering a search result reorganizer to manage reordering of search result links according to user interests predicted from user interactions with the search result links. In the example, the process starts at block 600 and thereafter proceeds to block 602. Block 602 illustrates a determination by a browser application, a website host, a search engine service, or other monitoring entity communicatively connected to a network, whether search result links responsive to a search query are detected. When the monitoring entity detects search result links responsive to a search query, the process passes to block 604. Block 604 illustrates the monitoring entity triggering a search result reorganizer to monitor user interactions with the search result links and to reorder the search result links to reflect user interest predicted from the current user interaction with the search result links, and the process ends. In one example, a browser is the monitoring entity detecting search result links returned in a website displayed within the browser, which prompts the browser to triggers the search result reorganizer. In another example, a set of search result links includes a flag or other setting that when read by the monitoring entity of a browser or a website host receiving the search result links, directs the browser or website host to trigger the search result reorganizer. Further, in another example, a search engine returning search result links may also by the monitoring entity that triggers a search result reorganizer. Moreover, a server hosting a website that includes an interface for a user to enter a search query and receive search results, may perform as the monitoring entity that triggers a search result reorganizer. Further, it will be understood that additional or alternate entities may trigger search result reorganizer for a selection of search result links.

Referring now to FIG. 7, a high level logic flowchart depicts a process and program for a search result reorganizer reordering search result links responsive to user interest predicted from current user interaction with the search result links. In the example, the process starts at block 700 and thereafter proceeds to block 702. Block 702 illustrates a determination whether a user interacts with the search result links or whether a new portion of the search result links displayed. If the user interacts with the search result links or a new portion of the search result links is displayed, then the process passes to block 704. Block 704 depicts gathering interaction data, including, but not limited to, times of interaction or display, data requested through an interaction, and the content of a selection of search result links associated with the user interaction or displayed.

Next, block 706 depicts a determination whether reordering of the search result links is triggered yet. In one example, search result reordering is triggered when a condition in the organization preferences is met. In another example, search result reordering may be specifically triggered by a search engine, by a website hosting an interface for a search engine, or by a user through a selectable option within a browser or website hosting an interface for a search engine to trigger reordering of the search result links. If reordering of search result links is not yet triggered, then the process returns to block 702. If reordering of search result links is triggered, then the process passes to block 708.

Block 708 illustrates predicting user interest based on the currently detected user interaction and any previously detected user interaction with the search result links. Next, block 710 depicts reorganizing the search result links based on the predicted user interest. Thereafter, block 712 illustrates a determination whether the user has closed the search result links. If the user is still accessing the search result links, then the process returns to block 702. If the user is no longer accessing the search result links, then the process ends.

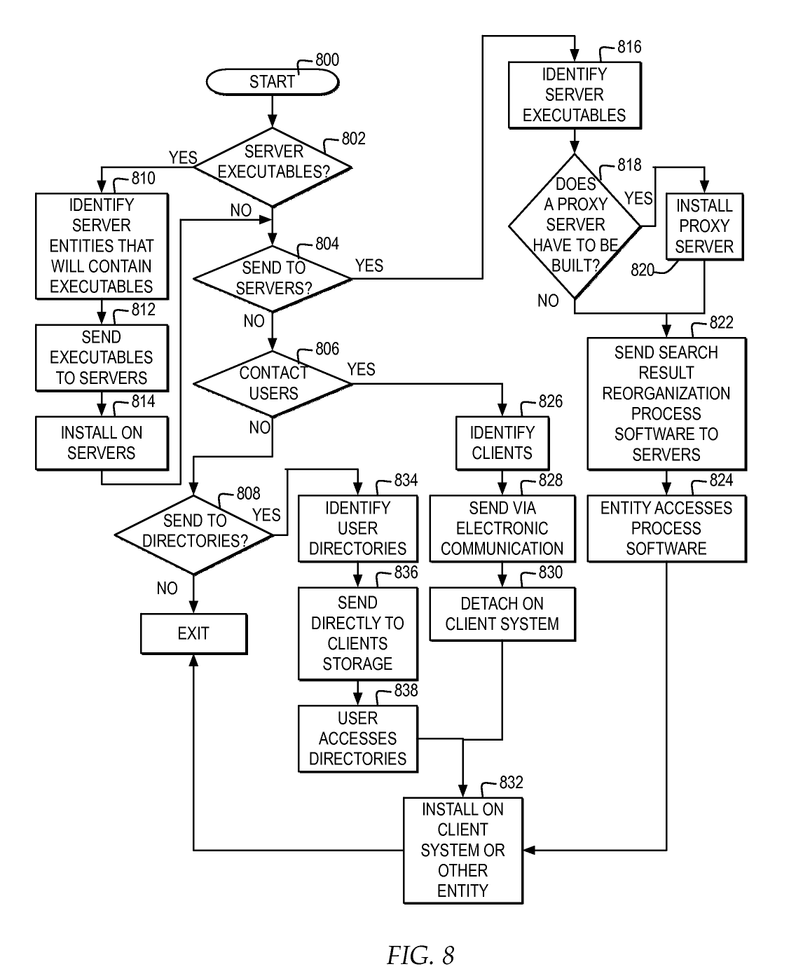

With reference now to FIG. 8, a high level logic flowchart depicts the deployment of the search result reorganizer process software. The first thing to determine is if there are any programs that will reside on a server or servers when the search result reorganizer process software is executed as illustrated in block 802. If this is the case, then the server entities that will contain the executables for the search result reorganizer process software are identified as depicted in block 810. The search result reorganizer process software for the server or servers is transferred directly to the server storage via file transfer protocol (FTP) or some other protocol or by copying through the use of a shared file system as illustrated in block 812. The search result reorganizer process software is then installed on the servers as depicted in block 814.

Next, a determination is made whether the search result reorganizer process software is to be deployed by having entities access the search result reorganizer process software on a server or servers as illustrated at block 804. If the entities to run the search result reorganizer process software are to access the process software on servers, then the server addresses that will store the search result reorganizer process software are identified as illustrated in block 816. Thereafter, a determination is made if a proxy server is to be built, as depicted in block 818 to store the search result reorganizer process software. A proxy server is a server that sits between a client application, such as a Web browser, and a physical server. The proxy server intercepts all requests to the physical server to see if the proxy server can fulfill the requests itself. If the proxy server cannot fulfill the requests to the physical server, then the proxy server forwards the request to the physical server. Two benefits of a proxy server are improving performance and filtering requests. If a proxy server is required, then the proxy server is installed, as depicted in block 820. The search result reorganizer process software is sent to the servers via file sharing as illustrated in block 822. Another embodiment would be to send a transaction to the servers that contained the search result reorganizer process software and have the server process the transaction, then receive and copy the process software to the server's file system. Once the search result reorganizer process software is stored at the server, the entities access the search result reorganizer process software on the servers and copy the search result reorganizer process software to their file system, as depicted in block 824. Another embodiment is to have the servers automatically copy the search result reorganizer process software to each entity and then the installation program for the search result reorganizer process software at each entity. The entity executes the program to install the search result reorganizer process software on the entity, such as a client system or other entity, and exits the process as depicted in block 832.

Otherwise, as to block 806, a determination is made whether the search result reorganizer process software is to be deployed by sending the search result reorganizer process software to entities via electronic communications. The set of entities where the search result reorganizer process software will be deployed are identified together with an electronic account address for each entity as illustrated in block 826. The search result reorganizer process software is sent via an electronic communication, such as an email, to each of the entity electronic account addresses as depicted in block 828. The entities receive the electronic communication sent to the entity electronic account address and detach the search result reorganizer process software from the communication to a directory on the entity as illustrated in block 830. The entity executes the program that installs the search result reorganizer process software on the entity, such as a client system or other entity, and then exits the process as depicted in block 832.

Further, otherwise, as to block 808, a determination is made whether the search result reorganizer process software will be sent directly to user directory on an entity, such as a user directory on a client system. If the search result reorganizer process software will be sent directly to the user directory of an entity, then the user directories are identified as illustrated in block 834. The search result reorganizer process software is transferred directly to the user directory as depicted in block 836. Transferring the search result reorganizer process software to the user directory can be done in several ways, such as, but not limited to, sharing of the file system directories and then copying from the sender's file system to the recipient user's file system or using a transfer protocol such as FTP. The users access the directories on their client file systems in preparation for installing the search result reorganizer process software as illustrated in block 838. The user executes the program that installs the search result reorganizer process software on the client system or other entity and then exits the process as depicted in block 832.

While the invention has been particularly shown and described with reference to a preferred embodiment, it will be understood by those skilled in the art that various changes in form and detail may be made therein without departing from the spirit and scope of the invention.

What is claimed is:

1. A method for ordering search results, comprising:
responsive to each user interaction with a plurality of search results to a plurality of separate network locations returned from a search request, predicting user interest in the plurality of search results from each user interaction; and
responsive to each prediction of user interest while a user interacts with the plurality of search results, reordering the plurality of search results to reflect the user interest.

2. The method according to claim 1, wherein predicting user interest in the plurality of search results from each user interaction further comprises:
detecting a first amount of time of the user interaction with the display interface with a first selection of the plurality of search results before selecting a next selection of the plurality of search results;
detecting at least one common content element from the first selection of the plurality of search results; and
predicting user interest in the at least one common content element based on the first amount of time.

3. The method according to claim 1, wherein predicting user interest in the plurality of search results from each user interaction further comprises:
detecting an amount of time a particular page accessed from a particular link within the plurality of search results is opened;
detecting at least one content element of the particular page; and
predicting user interest in the at least one content element based on the amount of time the particular page is opened.

4. The method according to claim 1, wherein predicting user interest in the plurality of search results from each user interaction further comprises:
detecting a first amount of time of a first user interaction with the plurality of search results and a first content element of the at least one page accessible from the plurality of search results associated with the first user interaction with the plurality of search results;
detecting a second amount of time of a second interaction of the user with the plurality of search results and a second content element of the at least one additional page accessible from the plurality of search results associated with the second interaction of the user with the plurality of search results;
predicting greater user interest in one of the first content element and the second content element based on a comparison of the first amount of time and the second amount of time.

5. The method according to claim 1, wherein predicting user interest in the plurality of search results from each user interaction further comprises:
detecting a user interaction of a user selecting to download a file from a website accessed from a particular link from among the plurality of search results;
detecting a type of content of the file; and
predicting user interest in the type of content of the file based on the user selecting to download the file from the website.

6. The method according to claim 1, wherein reordering the plurality of search results to reflect the user interest, further comprises:
detecting the predicted user interests based on each user interaction with at least one of the plurality of search results comprising at least one first content element from at least one of the pages accessible from at least one of the plurality of search results that is of highest interest to the user and at least one second content element from at least one of the additional pages accessible from at least one of the plurality of search results that is of lowest interest to the user; and
reordering the plurality of search results descending from at least one first link with the same at least one first content element of highest interest to the user to at least one second link with the same at least one second content element of lowest interest to the user.

7. The method according to claim 1, further comprising:
receiving the plurality of search results initially ordered by a search engine specifying the plurality of search results related to at least one search term in response to a search query with the at least one search term.

8. The method according to claim 1, further comprising:
responsive to each prediction of user interest while a user interacts with the plurality of search results, requesting a search engine perform a search query with an initial search term triggering the plurality of search results and at least one additional search term from the content indicated as of most interest to the user in the predicted user interest; and
receiving the reordered plurality of search results from the search engine for a search query based on the initial search term and the at least one additional search term based on the user interest.

9. A system for ordering search results, comprising:
a search engine for determining a plurality of search results to a plurality of separate network locations for at least one search term;
a search result reorganizer for detecting each user interaction with the plurality of search results from a search request, for predicting user interest in the plurality of search results from each user interaction, and, responsive to each prediction of user interest while a user interacts with the plurality of search results, for reordering the plurality of search results to reflect the user interest.

10. The system according to claim 9, wherein for predicting user interest in the plurality of search results from each user interaction the search result reorganizer further comprises:
means for detecting a first amount of time of the user interaction with a display interface with a first selection of the plurality of search results before selecting a next selection of the plurality of search results;
means for detecting at least one common content element from the first selection of the plurality of search results; and
means for predicting user interest in the at least one common content element based on the first amount of time.

11. The system according to claim 10, wherein the means for detecting at least one common content element of the pages accessible from the first selection of the plurality of search results further comprises:
means for detecting the common content element from among a plurality of tags detected for the pages accessible from the first selection the plurality of search results.

12. The system according to claim 9, wherein for predicting user interest in the plurality of search results from each user interaction the search result reorganizer further comprises:
means for detecting an amount of time a particular page accessed from a particular link within the plurality of search results is opened;
means for detecting at least one content element of the particular page; and
means for predicting user interest in the at least one content element based on the amount of time the particular page is opened.

13. The system according to claim 9, wherein for predicting user interest in the plurality of search results from each user interaction the search result reorganizer further comprises:
means for detecting a first amount of time of a first user interaction with the plurality of search results and a first content element of the at least one page accessible from the plurality of search results associated with the first user interaction with the plurality of search results;
means for detecting a second amount of time of a second interaction of the user with the plurality of search results and a second content element of the at least one additional page accessible from the plurality of search results associated with the second interaction of the user with the plurality of search results; and
means for predicting greater user interest in one of the first content element and the second content element based on a comparison of the first amount of time and the second amount of time.

14. The system according to claim 9, wherein for predicting user interest in the plurality of search results from each user interaction the search result reorganizer further comprises:
means for detecting a user interaction of a user selecting to download a file from a website accessed from a particular link from among the plurality of search results;
means for detecting a type of content of the file; and
means for predicting user interest in the content of the file based on the user selecting to download the file from the website.

15. The system according to claim 9, wherein for reordering the plurality of search results to reflect the user interest the search result reorganizer further comprises:
means for detecting the predicted user interests based on each user interaction with at least one of the plurality of search results comprising at least one first content element from at least one of the pages accessible from at least one of the plurality of search results that is of highest interest to the user and at least one second content element from at least one of the additional pages accessible from at least one of the plurality of search results that is of lowest interest to the user; and
means for reordering the plurality of search results descending from at least one first link with the same at least one first content element of highest interest to the user to at least one second link with the same at least one second content element of lowest interest to the user.

16. The system according to claim 9, further comprising a browser for facilitating the display interface for displaying the plurality of search results.

17. The system according to claim 9, the search result reorganizer further comprising:
means, responsive to each prediction of user interest while a user interacts with the plurality of search results, for requesting a search engine perform a search query with an initial search term triggering the plurality of search results and at least one additional search term from the content indicated as of most interest to the user in the predicted user interest; and
means for receiving the reordered plurality of search results from the search engine for a search query based on the initial search term and the at least one additional search term based on the user interest.

18. A program product comprising a storage-type computer-usable medium including a computer-readable program for ordering search results, wherein the computer-readable program when executed on a computer causes the computer to:
responsive to each user interaction with a plurality of search results to a plurality of separate network locations returned from a search request, predict user interest in the plurality of search results from each user interaction; and
responsive to each prediction of user interest while a user interacts with the plurality of search results, reorder the plurality of search results to reflect the user interest.

19. The program product according to claim 18, wherein the computer-readable program is transmitted over a network.

20. The program product according to claim 18, wherein the computer-readable program when executed on the computer further causes the computer to:
detect a first amount of time of the user interaction with a display interface with a first selection of the plurality of search results before selecting a next selection of the plurality of search results;
detect at least one common content element from the first selection of the plurality of search results; and
predict user interest in the at least one common content element based on the first amount of time.
